(19) United States
(12) Patent Application Publication
(10) Pub. No.: US 2002/0062478 A1
(43) Pub. Date: May 23, 2002

(54) Compiler for compiling source programs in an object-oriented programming language

(76) Inventors: Takahiro Ishikawa, Kawasaki (JP); Keishiro Tanaka, Kawasaki (JP); Yutaka Yamanaka, Kawasaki (JP)

Correspondence Address: STAAS & HALSEY LLP, 700 11TH STREET, NW, SUITE 500, WASHINGTON, DC, 20001, US

(21) Appl. No.: 09/778,087

(22) Filed: Feb. 7, 2001

(30) Foreign Application Priority Data
Oct. 5, 2000 (JP) 2000-305605

(51) Int. Cl. G06F 9/45

(52) U.S. Cl. 717/149

(57) ABSTRACT

The object of the present invention is to provide compiling technology to compile even source programs written in an object-oriented programming language so as to enable parallel processing. In order to realize parallel processing, in addition to the object 1000 specified by the source program, objects of said class for parallelization processing 1010, 1020 must be generated, for class variables specified by parallelization directive and class-type variables contained in execution statements to be executed in parallel. In addition, on completion of parallel processing, objects for parallelization processing are destroyed. For this reason, if execution statements to be executed parallel or the parallelization directive includes a class-type variable, the compiler generates an instruction to call a construction instruction routine for an object of the class before the execution statements to be executed in parallel or the execution statements to be parallelized by the parallelization directive, and generates an instruction to call a destruction instruction routine for an object of the class after the execution statements to be executed in parallel or the execution statements to be parallelized by the parallelization directive.

### TECHNICAL FIELD OF THE INVENTION

This invention relates to a compiler, more particularly to a compiler for compiling source programs written using an object-oriented programming language.

### BACKGROUND OF THE INVENTION

Java (a trademark of Sun Microsystems Corp.), C++ and other object-oriented programming languages are used in the development of numerous programs, for component-based design of programs and other reasons. Also, computers having a plurality of CPUs (central processing units) are also coming into wide use, due to falling CPU prices and other reasons.

Hence, there occur cases in which computers having a plurality of CPUs execute object programs generated from source programs written in an object-oriented programming language, but in the past, parallelization so as to exploit the capacity of a plurality of CPUs has not been performed.

### SUMMARY OF THE INVENTION

Hence, an object of the present invention is to provide compiler technology capable of compiling even source programs written in an object-oriented programming language so as to enable parallel processing.

In order to realize parallel processing, for class variables specified in parallelization directives and class type variables contained in execution statements to be executed in parallel, in addition to an object specified in the source program (original object 1000 in FIG. 1), objects of that class (objects 1010 and 1020 in FIG. 1 for parallelization processing) must be generated from the original object 1000. Further, on completion of parallel processing, the objects must be destroyed.

Hence, a compiler for compiling a source program in an object-oriented programming language causes a computer to execute the following steps of: if a class-type variable is contained in an execution statement to be executed in parallel or in a parallelization directive, generating and storing in a storage, an instruction for calling a construction instruction routine for an object of the class before the execution statement to be executed in parallel or an execution statement to be parallelized by the parallelization directive; and if a class-type variable is contained in an execution statement to be executed in parallel or in a parallelization directive, generating and storing in a storage, an instruction for calling a destruction instruction routine for an object of the class after the execution statement to be executed in parallel or an execution statement to be parallelized by the parallelization directive.

By this means, the necessary objects are generated at the time of execution, and parallel processing is realized. In addition, a generated object is destroyed if it becomes unnecessary.

If a compiler like that described above is executed on an ordinary computer, the computer becomes a compiler apparatus. The compiler is stored on a storage medium or a storage device, for example, a floppy disk, CD-ROM, magneto-optical disk, in semiconductor memory, or on a hard disk. Intermediate data during compiling is stored in the computer main memory or other storage device.

### BRIEF DESCRIPTION OF THE DRAWINGS

FIG. 1 is a schematic diagram at the time of execution of the object code generated according to the embodiment of the present invention;

FIG. 2 is a functional block diagram of a computer executing the compiler in the embodiment of the present invention;

FIG. 3 is a diagram showing one example of an intermediate language in the embodiment of the present invention;

FIG. 4 is a diagram showing the flow of processing for generation of the intermediate language in FIG. 3; and,

FIG. 5 is a diagram showing the flow of processing of parallelization processing using the intermediate language in FIG. 3.

### DETAIL DESCRIPTION OF THE PREFERRED EMBODIMENTS

FIG. 2 is a functional block diagram of one embodiment of the present invention. The computer 100 executes the compiler 120, which performs processing to compile a source program, stored in a source program file 110 and written in an object-oriented programming language. The result of processing by the compiler 120 is output as an object code file 130. This object code file 130 is executed by a parallel computer having a plurality of CPUs. There exist parallel computers in a variety of configurations, but an example of a program that assumes the OpenMP API (Application Program Interface) is described below. Therefore, in this embodiment, the computer is a shared-memory parallel computer.

The compiler 120 comprises a front end unit 122 which converts the source program into an intermediate language used for processing within the compiler; a parallelization processing unit 124 to execute processing for parallelization of the intermediate language generated by the front-end unit 122; and an object code generator 126 which generates object codes based on the processing results of the parallelization processing unit 124. Within the compiler 120, optimization processing and other processing is performed as necessary prior to the object code generation.

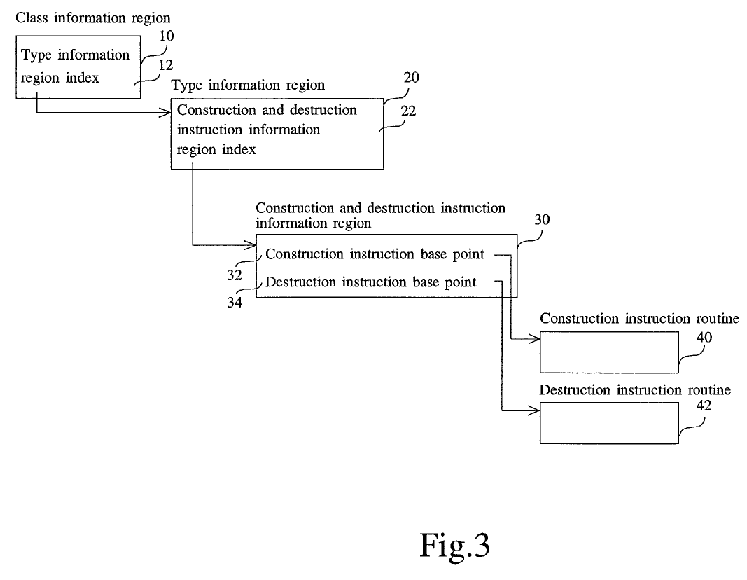

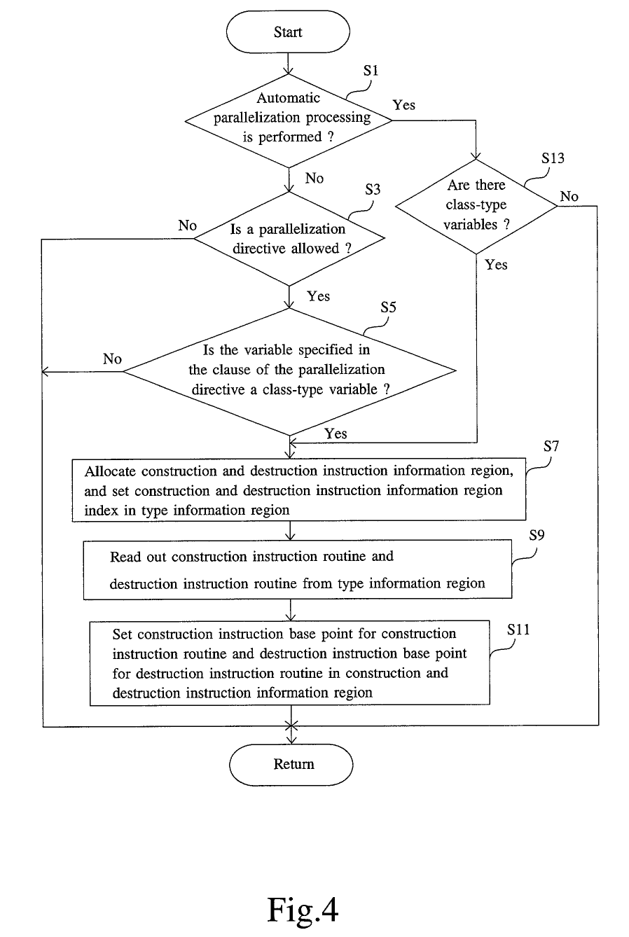

Next, the front-end unit 122 is explained. In this embodiment, in addition to conventional processing for generation of an intermediate language, processing like that shown in FIG. 4 is added, to generate an intermediate language (FIG. 3) differing from the conventional art. Conventionally, for each class, a class information region 10 for specifying the class, and a type information region 20 that stores type information for the class, and which are specified by the type information region index 12 contained in the class information region 10, are provided. In the type information region 20, information on the constructor (class construction instruction routine) and destructor (class destruction instruction routine) for the class are stored. In this embodiment, if a class is specified in the clause of a parallelization directive described according to the OpenMP API, following information is added to the conventional intermediate language for the class. In addition, in cases where automated parallelization processing is performed, the following information is added to the conventional intermediate language for all classes.

That is, the construction and destruction instruction information region 30 is added. The construction and destruction instruction information region index 22 is added to the type information region 20, specifying the construction and destruction information region 30. For the construction and destruction instruction information region 30, a construction instruction base point 32 specifying the construction instruction routine 40, and a destruction instruction base point 34 specifying the destruction instruction routine 42 are provided.

An explanation is given using a following program.

TABLE 1

| | |
|---|---|
| 01 | struct A{ |
| 02 | int mem1,mem2; |
| 03 | A(){mem1=0;mem2=1;} |
| 04 | A(A&a){mem1=a.mem1;mem2=a.mem2;} |
| 05 | ˜A(); |
| 06 | add(int I){mem1+=I;mem2+=I;} |
| 07 | }st; |
| 08 | A::˜A(){printf(“dtor call”);} |
| 09 | main(){ |
| 10 | #pragma omp parallel for private(st) |
| 11 | for (int I;I<=100000000;I++){ |
| 12 | st.add(I); |
| 13 | } |
| 14 | } |

The numbers on the left edge were added merely for the purpose of the following explanation, and normally are not included.

The above program is a source program written in C++; the first line is a part defining a structure called “A”. The second line is a statement defining the integer-type members mem1 and mem2. The third line is a statement defining the constructor A(). The fourth line is a copy constructor. The fifth destructor ˜A(). The sixth line is a statement defining a method called “add”. The seventh line is a part defining the class variable st of the structure as described above. The eighth line is a statement defining the destructor. The ninth line is the beginning part of the main program “main”. The tenth line is an OpenMP parallelization directive (#pragma omp parallel). The “for” in the tenth line indicates that subsequent “for” loop is parallelized, and “private(st)” indicates that the class variable st is private for each thread. The eleventh line stipulates a “for” loop in which I is incremented by 1 each time, from I=0 to I=100000000. The twelfth line presents the “add” method of the class st in the sixth line. The 13th line stipulates completion of the “for” loop, and the 14th line stipulates completion of the main program.

In order to perform parallel processing of the program described in Table 1, objects for parallelization processing have to be constructed and destructed in addition to the original object. Therefore, the constructor including st.mem1=0 and st.mem2=0 and the destructor st.˜A() are necessary for each object for parallelization processing. The method st.add is executed for each object for parallelization processing. The range of I used in the “for” loop in objects for parallelization processing is determined by the number of objects for parallelization processing.

In the case of the program of Table 1, in this embodiment of the present invention, the class st is specified in the object information region 10. In the type information region 20, information for the structure A, including the constructor A() and destructor ˜A(), is stored. In the construction and destruction instruction information region 30, the construction instruction base point 32 to st.mem1=0 and st.mem2=1, of which the construction instruction routine (constructors) 40 is composed, and the destruction instruction base point 34 to st.˜A(), which is the destruction instruction routine (destructor) 42, are stored.

The processing flow to add information like the above to the conventional intermediate language is explained using FIG. 4. Initially, it is judged whether or not automatic parallelization processing is performed (step S1). The above judgment is performed on the basis of, for example, whether a user setting to perform the automatic parallelization processing has been made for the compiler 120. If automatic parallelization processing is to be performed, it is judged whether class-type variables exist in the current statement to be processed (step S13). If there are class-type variables, execution is shifted to step S7. If there are no class-type variables, processing returns to the upper-level processing.

If it is judged at the step S1 that automatic parallelization processing is not performed, it is judged whether use of a parallelization directive is allowed (step S3). The parallelization directive is, for example, a parallelization directive in OpenMP, whether use of parallelization directives is allowed is judged on the basis of, for example, whether a user setting to allow the use of parallelization directives has been made for the compiler 120. If use of parallelization directives is not allowed, processing returns to the upper-level processing. If use of parallelization directives is allowed, it is judged whether the variable specified in the clause of the parallelization directive is a class-type variable (step S5). In the example of Table 1, the clause is “private”, the variable is st, and it is a class-type variable. If the variable is not a class-type variable, processing returns to the upper-level processing.

If the variable specified by the clause of the parallelization directive is a class-type variable, a construction and destruction instruction information region 30 is allocated for the class, and a construction and destruction instruction information region index 22 is set within the type information region 20 (step S7). The construction instruction routine 40 and destruction instruction routine 42 are read out from the type information region 20 (step S9), and the construction instruction base point 32 for the construction instruction routine 40, and the destruction instruction base point 34 for the destruction instruction routine 42, are set within the construction and destruction instruction information region 30 (step S11).

By this means, an intermediate language like that shown in FIG. 3 is generated. If an intermediate language like that shown in FIG. 3 is prepared in a storage device, the subsequent parallelization processing can be performed rapidly and reliably.

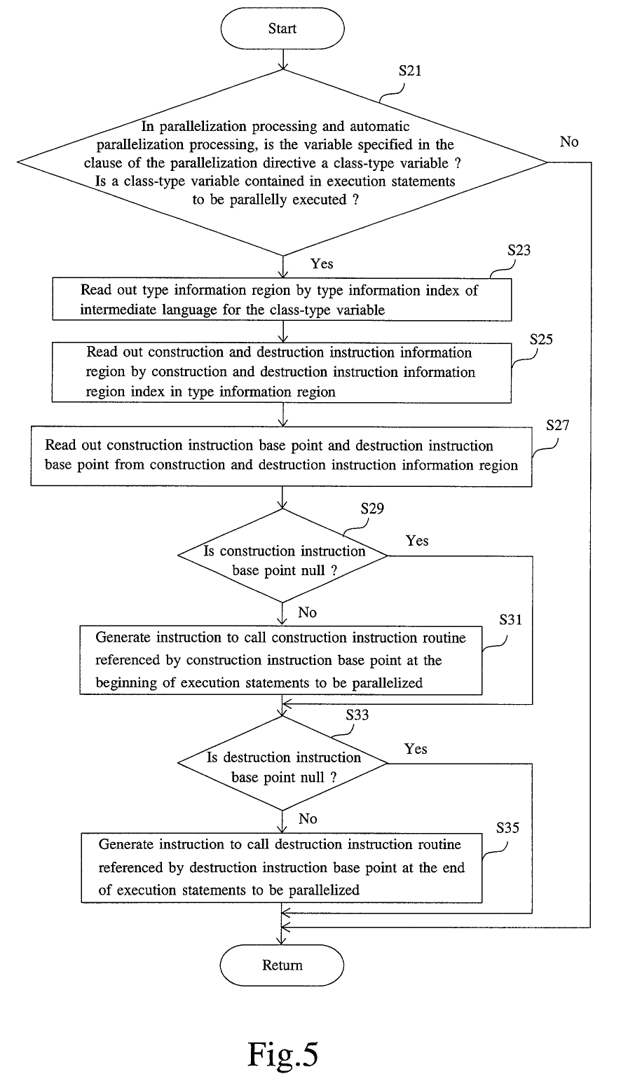

Next, the flow of processing of the part added to the parallelization processing unit 124 in this embodiment is shown in FIG. 5. First, in parallelization processing and automatic parallelization processing, it is judged whether the variable specified by the clause of a parallelization directive is a class-type variable, or whether a class-type variable is contained in the execution statement to be executed in parallel (step S21). If the variable specified by the clause of the parallelization directive is not a class-type variable, and no class-type variable is contained in the execution statement to be executed in parallel, processing returns to the upper level processing.

On the other hand, if the variable specified by the clause of the parallelization directive is a class-type variable, or the class-type variable is contained in the execution statement to be executed in parallel, information in the type information region 20 is read out by the type information region index 12 in the class information region 10 of the intermediate language of the class-type variable (step S23). Information in the construction and destruction instruction information region 30 is read out by the construction and destruction instruction information region index 22 in the type information region 20 (step S25).

Next, the construction instruction base point 32 and destruction instruction base point 34 are read out from the construction and destruction instruction information region 30 (step 27). It is judged whether the construction instruction base point 32 indicates NULL (no information) (step S29). If it indicates NULL, processing skips to step S33. If it does not indicate NULL, an instruction is generated which calls, at the beginning of the execution statement to be parallelized, the construction instruction routine 40 referenced by the construction instruction base point 32, and stores the instruction in a storage device (step S31).

Then, it is judged whether the destruction instruction base point 34 indicates NULL (no information) (step S33). If it indicates NULL, processing returns to the upper-level processing. If it does not indicate NULL, an instruction is generated which calls, at the end of the execution statement to be parallelized, the destruction instruction routine 42 referenced by the destruction instruction base point 34, and stores the instruction in a storage device (step S35). Processing then returns to the upper-level processing.

The instruction group additionally generated in this way in FIG. 5, and the instruction group generated by the parallelization processing unit 124 of the compiler 120, are used by the object code generator 126 to generate object code and to store the object code in the object code file 130. As explained above, other processing (for example, optimization processing) may be performed after processing in the parallelization processing part 124, and the object code may be generated for the instruction group after this optimization processing, for example.

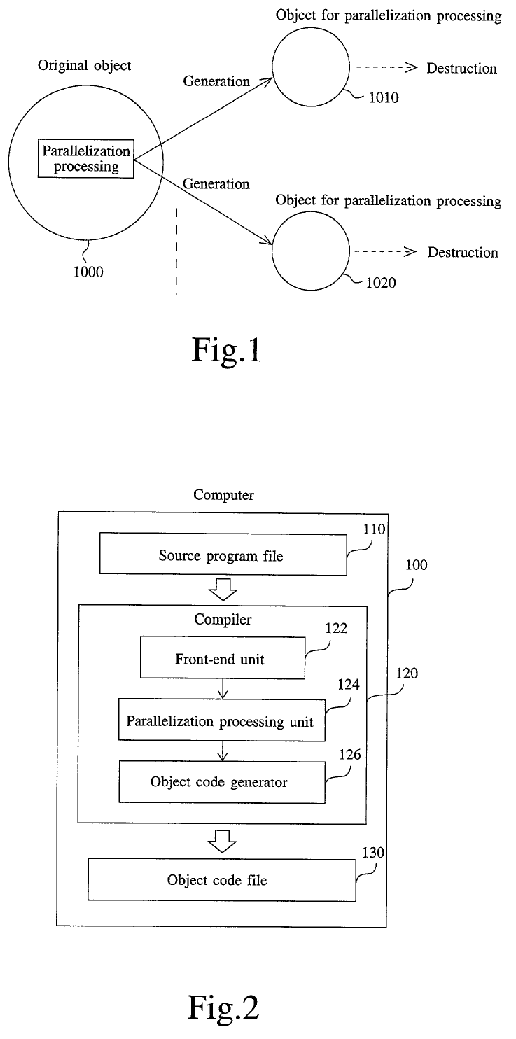

The object code comprises object code corresponding to an instruction which calls the construction instruction routine 42 to generate objects for parallelization processing such as shown in FIG. 1, and object code corresponding to an instruction which calls the destruction instruction routine 44 to destruct the objects for parallelization processing. However, the number of objects for parallelization processing generated at the time of execution of the object code depends on the capacity of the parallel computer executing the object code, and so is unknown at this point of time. Hence, an instruction to call the construction instruction routine 42 and an instruction to call the destruction instruction routine 44 are not generated in numbers equal to the numbers of objects for parallelization processing.

In the above, an embodiment of this invention has been explained, but this invention is not limited to this embodiment. For example, the order of the steps S29 and S31 and of steps S33 and S35 in FIG. 5 can be interchanged. Also, the computer 100 in FIG. 1 may be connected to a network, and the source program file 110 may be sent from another computer, or the object code file 130 may be sent to another computer. There are also cases in which another computer is a parallel computer. In the above, an example of a program that assumes OpenMP was given, but programs may conform to other standards as well.

In this way, compiler technology can be provided which is capable of compiling even source programs written in an object-oriented language so as to enable parallel processing.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A storage medium for storing a compiler to compile a source program in an object-oriented programming language, said compiler comprising the steps of:
if a class-type variable is contained in an execution statement to be executed in parallel or in a parallelization directive, generating an instruction to call a construction instruction routine for an object of the class before said execution statement to be executed in parallel or an execution statement to be parallelized by said parallelization directive; and
if a class-type variable is contained in an execution statement to be executed in parallel or in a parallelization directive, generating an instruction to call a destruction instruction routine for an object of the class after said execution statement to be executed in parallel or an execution statement to be parallelized by said parallelization directive.

2. The storage medium according to claim 1, said compiler further comprising the steps of:
when generating an intermediate language from said source program,
allocating a construction and destruction instruction information region in the intermediate language of the class, if a class variable which has possibility to be executed in parallel is specified; and
storing into said construction and destruction instruction information region, information concerning a construction instruction routine and a destruction instruction routine of an object of the class, and
wherein information stored in said construction and destruction instruction information region is used in said steps of generating an instruction to call a construction instruction routine and
generating an instruction to call a destruction instruction routine.

3. The storage medium according to claim 2, wherein said construction and destruction instruction information region is structured so as to be accessed from the type information of said class.

4. The storage medium according to claim 1, wherein said compiler is a compiler for a parallel computer with shared memory.

5. A compiling apparatus for compiling a source program in an object-oriented programming language, comprising:
means for, if a class-type variable is contained in an execution statement to be executed in parallel or in a parallelization directive, generating an instruction to call a construction instruction routine for an object of the class before said execution statement to be executed in parallel or an execution statement to be parallelized by said parallelization directive; and
means for, if a class-type variable is contained in an execution statement to be executed in parallel or in a parallelization directive, generating an instruction to call a destruction instruction routine for an object of the class after said execution statement to be executed in parallel or an execution statement to be parallelized by said parallelization directive.

6. The compiling apparatus according to claim 5, further comprising:
means for allocating a construction and destruction instruction information region in the intermediate language of the class during generation of an intermediate language from said source program, if a class variable which has possibility to be executed in parallel is specified; and
means for storing into said construction and destruction instruction information region, information concerning a construction instruction routine and a destruction instruction routine of an object of the class, and
wherein information stored in said construction and destruction instruction information region is used by said means for generating an instruction to call a construction instruction routine and said means for generating an instruction to call a destruction instruction routine.

7. The compiling apparatus according to claim 6, wherein said construction and destruction instruction information region is structured so as to be accessed from the type information of said class.

8. The compiling apparatus according to claim 1, wherein said compiling apparatus is a compiling apparatus for a parallel computer with shared memory.

9. A compiling method for compiling a source program in an object-oriented programming language, said compiling method comprising the steps of:
if a class-type variable is contained in an execution statement to be executed in parallel or in a parallelization directive, generating an instruction to call a construction instruction routine for an object of the class before said execution statement to be executed in parallel or an execution statement to be parallelized by said parallelization directive; and
if a class-type variable is contained in an execution statement to be executed in parallel or in a parallelization directive, generating an instruction to call a destruction instruction routine for an object of the class after said execution statement to be executed in parallel or an execution statement to be parallelized by said parallelization directive.

10. The compiling method according to claim 1, further comprising the steps of:
when generating an intermediate language from said source program,
allocating a construction and destruction instruction information region in the intermediate language of the class, if a class variable which has possibility to be executed in parallel is specified; and
storing into said construction and destruction instruction information region, information concerning a construction instruction routine and a destruction instruction routine of an object of the class, and
wherein information stored in said construction and destruction instruction information region is used in said steps of generating an instruction to call a construction instruction routine and
generating an instruction to call a destruction instruction routine.

11. The compiling method according to claim 10, wherein said construction and destruction instruction information region is structured so as to be accessed from the type information of said class.

12. The compiling method according to claim 9, wherein said compiling method is a compiling method for a parallel computer with shared memory.
